(19) United States
(12) Patent Application Publication
(10) Pub. No.: US 2025/0379323 A1
(43) Pub. Date: Dec. 11, 2025

(54) COVER ASSEMBLY FOR BATTERY MODULE, BATTERY PACK, AND VEHICLE INCLUDING THE SAME

(71) Applicant: LG ENERGY SOLUTION, LTD., Seoul (KR)

(72) Inventors: Ki Taek JUNG, Daejeon (KR); Won Kyoung PARK, Daejeon (KR); Young Gil KIM, Daejeon (KR)

(73) Assignee: LG ENERGY SOLUTION, LTD., Seoul (KR)

(21) Appl. No.: 19/307,387

(22) Filed: Aug. 22, 2025

Related U.S. Application Data
(63) Continuation of application No. PCT/KR2024/020284, filed on Dec. 12, 2024.

(30) Foreign Application Priority Data
Jun. 10, 2024 (KR) 10-2024-0075260

(51) Int. Cl. H01M 50/342; H01M 10/658; H01M 50/204; H01M 50/249; H01M 50/276

(52) U.S. Cl. CPC H01M 50/3425; H01M 10/658; H01M 50/249; H01M 50/276; H01M 50/204

(57) ABSTRACT

A cover assembly for a battery module including a cover frame configured to be coupled to one opened side of a battery module casing and to close the opened side of the battery module casing, the cover frame including a plurality of hollow portions extending in a longitudinal direction, and a plurality of venting holes at locations that overlap the plurality of hollow portions, the plurality of venting holes being configured to penetrate the cover frame in a direction toward an inside of the battery module casing, and at least one venting part inserted into a first hollow portion and configured to close a respective venting hole of the plurality of venting holes, each at least one venting part having a portion that corresponds to the respective venting hole, each at least one venting part being configured to be opened when gas or flame is generated in the battery module.

### CROSS REFERENCE TO RELATED APPLICATIONS

This application is a Continuation of PCT International Application No. PCT/KR2024/020284, filed on Dec. 12, 2024, which claims priority under 35 U.S.C. 119(a) to Patent Application No. 10-2024-0075260, filed in the Republic of Korea on Jun. 10, 2024, all of which are hereby expressly incorporated by reference into the present application.

### TECHNICAL FIELD

The present disclosure relates to a cover assembly for a battery module, the cover assembly being capable of improving safety by smoothly discharging gas or flame generated in an abnormal battery situation, a battery pack, and a vehicle including the same.

### BACKGROUND ART

Recently, a technology for reducing carbon has been actively developed to solve environmental issues such as abnormal atmospheric temperatures. In order to reduce carbon, energy needs to be produced by environmentally friendly methods instead of fossil fuel, the produced energy needs to be stored in the form of electrical energy, and the stored electrical energy needs to be used for vehicles, various types of industrial sites, and homes.

In order to utilize electrical energy while reducing carbon, it is essential to use batteries capable of storing and retrieving electrical energy. Therefore, it is essential to ensure the performance of the battery to sufficiently store electrical energy and use the electrical energy without discomfort.

The battery mainly uses a redox reaction of metal ions. The battery uses metal ions with a high density to improve a capacity of the battery and charging and discharging performance and efficiency of the battery. Many studies are also being conducted on materials, which constitute electrolytes, and on solid electrolytes and the like. However, there is a general problem in that stability deteriorates as the performance of the battery is developed.

Batteries used in vehicles, industries, or homes are manufactured in physical units called packs. The battery pack is configured such that a plurality of battery cells is embedded in a battery casing and sealed. The battery pack serves to prevent fire from spreading to the outside even in the event of an accident such as thermal runaway in the battery and protect the battery cells therein so that the battery cells are not degraded by being affected by an external environment, or the battery cells are not physically damaged by an external environment.

In the battery pack, the plurality of battery cells is embedded in an intermediate form of a module or an assembly (cell module assembly (CMA)). The battery module or the assembly is configured by assembling the plurality of battery cells into one module or assembly. A plurality of modules is fastened into a pack casing, such that the battery pack is completely manufactured. When the battery is maintained, the maintenance may be performed on the unit of the module or the assembly, which facilitates the maintenance.

A plurality of unit battery cells, which constitutes the module or the assembly, includes a positive electrode, a negative electrode, and an electrolyte. Because the battery cell generates heat when the battery cell is charged and discharged, it is necessary to effectively dissipate heat from the battery cell. In addition, the battery module, the assembly, or the battery pack needs to be designed to efficiently dissipate heat to prevent a safety accident.

Meanwhile, the battery may be degraded when the battery is subjected to manufacturing errors, when the battery is excessively charged or discharged, or when the battery ages. Further, when the battery continues to deteriorate, a fire may eventually occur. Therefore, it is necessary to prepare in advance to prevent a fire from occurring in the battery. To this end, it is important to consistently sense a state of the battery and recognize and cope with, in advance, a problem when the problem occurs. In the event of an unexpected problem, it is necessary to minimize damage.

In particular, in the event of a fire in a particular battery module or battery cell in a battery pack, gas or flame may easily propagate to the adjacent battery module or the adjacent battery cell because the inside of the battery pack is sealed. Therefore, in the event of a fire in a particular battery module or battery cell present in the battery pack, it is important to smoothly vent gas from the battery module or the battery cell, in which the fire occurs, and to prevent or delay the propagation of flame to the adjacent battery module or the adjacent battery cell.

The foregoing explained as the background is intended merely to aid in the understanding of the background of the present disclosure, and is not intended to mean that the present disclosure falls within the purview of the related art that is already known to those skilled in the art.

### DISCLOSURE

### Technical Problem

The present disclosure has been made in an effort to solve the above-mentioned problem, and an object of the present disclosure is to provide a cover assembly for a battery module, a battery pack, and a vehicle including the same, in which the cover assembly is configured such that venting parts are inserted into a cover frame having hollow portions and venting holes in the event of a fire in a particular battery module or battery cell, such that a cover of the battery module is prevented from separating in the event of the fire, gas or flame is smoothly discharged from the battery module or the battery cell in which the fire occurs, and the gas or flame is prevented from propagating to the adjacent battery module or the adjacent battery cell.

Technical problems to be solved by the present disclosure are not limited to the above-mentioned technical problems, and other technical problems, which are not mentioned above, may be clearly understood from the following descriptions by those skilled in the art to which the present disclosure pertains.

### Technical Solution

In order to achieve the above-mentioned object, a cover assembly for a battery module according to the present disclosure includes a cover frame configured to be coupled to one opened side of a battery module casing and to close the opened side of the battery module casing, the cover frame including a plurality of hollow portions extending in a longitudinal direction; and a plurality of venting holes at locations that overlap the plurality of hollow portions, the plurality of venting holes being configured to penetrate the cover frame in a direction toward an inside of the battery module casing, and at least one venting part inserted into a first hollow portion of the plurality of hollow portions and configured to close a respective venting hole of the plurality of venting holes, each at least one venting part having a portion that corresponds to the respective venting hole, each at least one venting part being configured to be opened when gas or flame is generated in the battery module.

In the case of the cover assembly for a battery module according to the present disclosure, the first hollow portion may extend to an end of the cover frame, and each at least one venting part may be inserted into the first hollow portion through an end of the cover frame.

In the case of the cover assembly for a battery module according to the present disclosure, the plurality of hollow portions may are spaced apart from one another in parallel.

In the case of the cover assembly for a battery module according to the present disclosure, the at least one venting part may be provided as a plurality of venting parts, and each of the plurality of venting parts may be individually inserted into corresponding hollow portions of the plurality of hollow portions and coupled to the cover frame.

In the case of the cover assembly for a battery module according to the present disclosure, each of the plurality of venting holes may include a first hole located in an inner surface of the cover frame, and a second hole located in an outer surface of the cover frame, and the first hole and the second hole may be configured to communicate with each other through a corresponding hollow portion of the plurality of hollow portions.

In the case of the cover assembly for a battery module according to the present disclosure, the second hole may be larger in width than the first hole.

In the case of the cover assembly for a battery module according to the present disclosure, a fractured portion may be formed on the venting part and configured to be opened when gas or flame is generated in the battery module, and the first hole and the second hole may be located to face each other with the hollow portion interposed therebetween, such that the fractured portion may be disposed between the first hole and the second hole.

In the case of the cover assembly for a battery module according to the present disclosure, the fracturable portion may be larger in width than the first hole and smaller in width than the second hole.

In the case of the cover assembly for the battery module according to the present disclosure, the cover frame may be made of a metallic material.

In the case of the cover assembly for a battery module according to the present disclosure, the cover frame may be formed by an extrusion process method so that the plurality of hollow portions are integrally formed therein.

In the case of the cover assembly for a battery module according to the present disclosure, the plurality of venting holes may be formed by forming a hole in the cover frame formed by extrusion.

In the case of the cover assembly for a battery module according to the present disclosure, each of the plurality of venting holes may have a first hole located in an inner surface of the cover frame, and a second hole located in an outer surface of the cover frame, and the second hole may be larger in width than the first hole by additional processing.

In the case of the cover assembly for a battery module according to the present disclosure, an end of the first hollow portion may be pressed and deformed after the at least one venting part is inserted, such that the at least one venting part may be prevented from being withdrawn.

In the case of the cover assembly for a battery module according to the present disclosure, an end cover may be located at an end of the first hollow portion, and the end cover may prevent the at least one venting part, which is inserted into the first hollow portion, from being withdrawn to an outside of the cover frame.

In the case of the cover assembly for a battery module according to the present disclosure, an end of the first hollow portion may be welded and closed in a state in which the at least one venting part is inserted, such that the at least one venting part may be prevented from being withdrawn to the outside of the cover frame.

In the case of the cover assembly for a battery module according to the present disclosure, the venting part may be made of a fire-resistance material.

In the case of the cover assembly for a battery module according to the present disclosure, a temporarily cut line may be located on the venting part along a shape of the respective venting hole.

In the case of the cover assembly for a battery module according to the present disclosure, the temporarily cut line of the venting part may be configured to be cut (separated) when gas or flame is generated in the battery module, and a portion of the at least one venting part, may be opened, such that a through-hole may be formed.

In the case of the cover assembly for a battery module according to the present disclosure, the through-hole of the venting part may be larger in width than the first hole and smaller in width than the second hole.

A battery pack according to the present disclosure includes the above-mentioned cover assembly for a battery module.

A vehicle according to the present disclosure includes the above-mentioned battery pack.

### Advantageous Effects

According to the cover assembly for a battery module, a battery pack, and a vehicle including the same according to the present disclosure, the cover assembly, in which the venting parts are inserted into the cover frame having the hollow portions and the venting holes, prevents the module cover from separating in the event of a fire in a particular battery module or battery cell, such that gas or flame is prevented from propagating to the adjacent battery module or the adjacent battery cell, and the gas or flame is smoothly vented from the battery module or battery cell having problems, thereby improving safety of the entire high-level system that utilizes the cover assembly for a battery module.

The effects obtained by the present disclosure are not limited to the aforementioned effects, and other effects, which are not mentioned above, will be clearly understood by those skilled in the art from the following description.

### DESCRIPTION OF DRAWINGS

FIG. 1 is a perspective view illustrating a cover assembly for a battery module according to an embodiment of the present disclosure.

FIG. 2 is an enlarged perspective view of insert A illustrated in FIG. 1.

FIG. 3 is a plan view illustrating a cross-section of a cover frame illustrated in FIG. 1.

FIG. 4 is a view illustrating a state in which venting parts are inserted into the cover frame illustrated in FIG. 1.

FIG. 5 is a view illustrating a cross-section taken along line C-C′ illustrated in FIG. 4.

FIG. 6 is a view illustrating a cross-section taken along line B-B′ illustrated in FIG. 4.

FIG. 7 is a view illustrating a cross-section in a state in which a temporarily cut line illustrated in FIG. 4 is opened.

FIG. 8 is a perspective view illustrating a state in which a cross-sectional cover is formed in a cross-section of the cover frame illustrated in FIG. 1.

FIG. 9 is a view illustrating a method of forming a venting hole according to the embodiment of the present disclosure.

FIG. 10 is a view illustrating a method of forming a venting hole according to another embodiment of the present disclosure.

FIG. 11 is a view illustrating a cross-section of the venting hole formed by the method according to FIGS. 9 and 10.

FIG. 12 is a view illustrating a method of forming a first hole and a second hole according to the embodiment of the present disclosure after the method according to FIGS. 9 and 10.

FIG. 13 is a view illustrating a cross-section of the first hole and the second hole formed by the method according to FIG. 12.

FIG. 14 is a view illustrating a battery pack and a vehicle to which the cover assembly for a battery module according to the present disclosure is applied.

### MODE FOR INVENTION

In the description of the embodiments disclosed in the present specification, the specific descriptions of publicly known related technologies will be omitted when it is determined that the specific descriptions may obscure the subject matter of the embodiments disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element. Singular expressions include plural expressions unless clearly described as different meanings in the context. In the present specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

The suffixes “module”, “unit”, “part”, and “portion” used to describe constituent elements in the following description are used together or interchangeably in order to facilitate the description, but the suffixes themselves do not have distinguishable meanings or functions. When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

Hereinafter, embodiments disclosed in the present specification will be described in detail with reference to the accompanying drawings. The same or similar constituent elements are assigned with the same reference numerals regardless of the reference numerals, and the repetitive description thereof will be omitted. A battery cell is the most basic unit that constitutes a battery, and thermal runaway refers to a phenomenon in which the battery cell explodes or a fire occurs because of an excessively high temperature of the battery cell. In addition, a situation in which thermal runaway occurring in one battery cell propagates to the adjacent battery cell while releasing a significant amount of heat refers to thermal propagation. Therefore, in order to prevent explosion of the battery, it is important to prepare a technology for maximally preventing thermal propagation when thermal runaway occurs in one battery cell.

The thermal runaway, which occurs in the battery cell or the battery module including the plurality of battery cells, may be caused by various factors such as physical factors, such as corrosion, collision, and deformation of the battery, electrical factors, such as a short circuit from the outside and overcharging or overdischarging of the battery, and thermal factors, such as an increase in temperature of the battery cell caused by an external heat source or the like.

When thermal runaway occurs in the battery, a fire or explosion occurs. In this case, thermal propagation in which the thermal runaway propagates to the adjacent battery module or the adjacent battery cell occurs. It is very difficult to cope with the thermal propagation because of a risk of a high fire intensity and continuous explosion. Therefore, there is a need for a technology for preventing thermal propagation before the thermal propagation occurs.

In the related art, because a cover of a battery module separates under a high-temperature, a high-pressure environment caused by thermal runaway when thermal runaway occurs in a battery module, in which a plurality of battery cells is embedded, or the battery cell embedded in the battery module, flame or gas propagates to the adjacent battery module or the adjacent battery cell, and the gas or flame cannot be smoothly vented from the battery module or battery cell in which the thermal runaway occurs.

The present disclosure proposes a cover assembly for a battery module, in which venting parts 500 made of a fire-resistance material is introduced into a cover frame 300 of the battery module having hollow portions 360 and venting holes 340, such that a cover of the battery module is prevented from separating, and thermal propagation to the adjacent battery module or the adjacent battery cell is prevented or delayed even though thermal runaway occurs in the battery module or the battery cell.

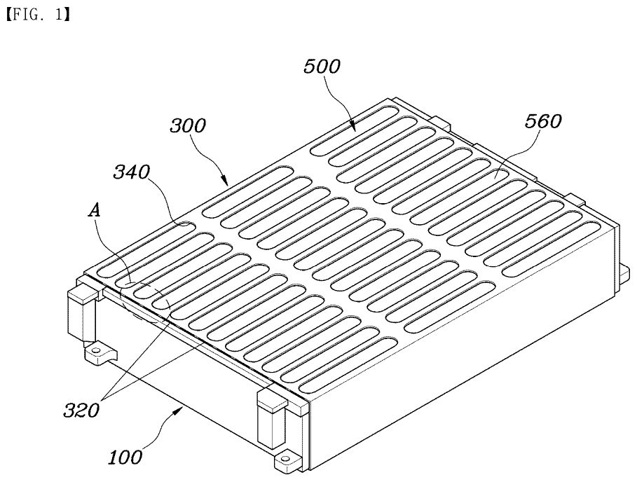

Specifically, as illustrated in FIG. 1, the cover assembly for a battery module of the present disclosure includes the cover frame 300 and the venting parts 500. A plurality of hollow portions 360 is formed in the cover frame 300, and the venting parts 500 are inserted into the hollow portions 360 through ends 320 of the hollow portions 360. In addition, the venting holes 340 are formed in the cover frame 300, provided at points overlapping the hollow portions 360, and configured to penetrate the cover frame 300 in a direction toward a battery module casing 100, such that gas or flame may be discharged to the outside through the venting holes 340 in the event of thermal runaway in the battery module or the battery cell. Because the end 320 of the hollow portion 360 and the venting hole 340 communicate with each other through the hollow portion 360, a portion of the venting part 500, which corresponds to the venting hole 340, is exposed to the outside while closing the venting hole 340 in case that the venting part 500 is inserted into the hollow portion 360 through the end 320 of the hollow portion 360.

As illustrated in FIG. 1, the venting part 500 is inserted into the hollow portion 360 of the cover frame 300 and closes the venting hole 340. The venting part 500 is inserted and coupled into the cover frame 300 and configured such that a portion of the venting part 500, which corresponds to the venting hole 340, is opened when gas or flame is generated in the battery module. Because the venting part 500 is inserted and coupled into the cover frame 300 as described above, the cover of the battery module does not separate even in the event of thermal runaway in a particular battery module or battery cell, such that gas or flame may be smoothly vented from the battery module or battery cell in which the thermal runaway occurs, and thermal propagation to the adjacent battery module or the adjacent battery cell is prevented.

As illustrated in FIG. 1, the plurality of hollow portions 360 is formed in the cover frame 300 of the cover assembly for a battery module, and the plurality of hollow portions 360 is disposed in the cover frame 300 and spaced apart from one another in parallel. Therefore, the venting parts 500, which are inserted into the hollow portions 360, are also provided as a plurality of venting parts 500, and the plurality of venting parts 500 is coupled to the cover frame 300 by being individually inserted into the hollow portions 360. That is, as illustrated in FIG. 2, the venting part 500 is provided in a single line (planar) shape and inserted into the hollow portion 360, which is formed in a longitudinal direction of the cover assembly for a battery module, through the end 320 of the hollow portion 360. The venting parts 500 are coupled to the cover assembly for a battery module by being individually inserted into the hollow portions 360 through the ends 320 of the hollow portions 360.

The venting part 500 is disposed in the cover frame 300 and coupled to the cover frame 300 by being inserted into the hollow portion 360 through the end 320 of the hollow portion 360 of the cover frame 300. Because the venting part 500 has a single line shape, the venting part 500 may be inserted into the hollow portion 360 through the end 320 of the hollow portion 360 in a sliding manner or inserted into the hollow portion 360 through the end 320 of the hollow portion 360 in a mechanical manner such as fitting, such that the venting part 500 may be coupled into the cover frame 300.

Because the venting part 500 is provided as a single member and individually inserted into the hollow portion 360, it is possible to prevent thermal propagation, in which thermal runaway propagates to the adjacent venting part 500, even though any one venting part 500 is opened in the event of thermal runaway in a particular battery module or battery cell. With reference to FIG. 7, even in case that thermal runaway occurs in a battery cell at a position at which the left venting part 500 is disposed, the right venting part 500 is not opened because the adjacent venting part 500 disposed at the right side is individually inserted and coupled. Therefore, in case that thermal runaway occurs at a position at which the left venting part 500 is positioned, a fractured portion 560 of the left venting part 500 is opened to form a through-hole 580, such that gas or flame is smoothly discharged. At the same time, the fractured portion 560 of the adjacent venting part 500 positioned at the right side still may not be opened, thereby preventing the propagation of gas or flame. Therefore, it is possible to prevent or delay the thermal propagation in the battery module.

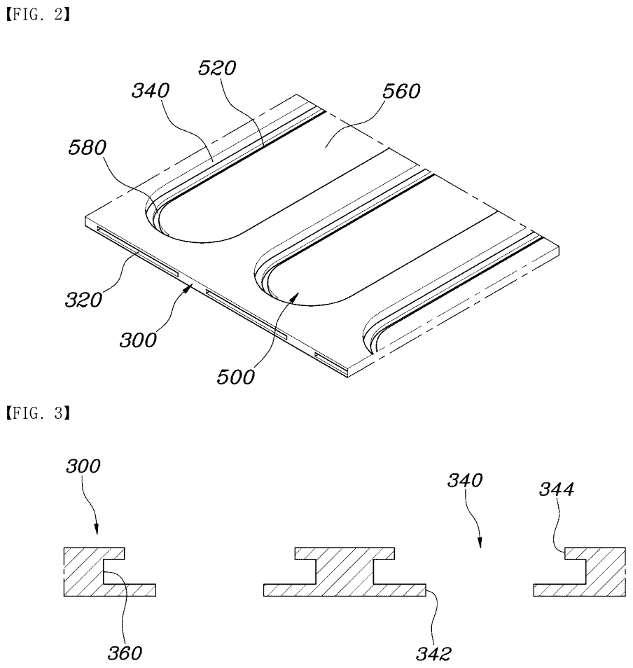

The venting hole 340 is formed to penetrate the cover frame 300. Specifically, as illustrated in FIG. 3, the venting hole 340 includes a first hole 342 formed in an inner surface of the cover frame 300 and a second hole 344 formed in an outer surface of the cover frame 300. The first hole 342 and the second hole 344 are provided at positions facing each other and communicate with each other through the hollow portion 360. The second hole 344 is larger in width and size than the first hole 342. The first hole 342 and the second hole 344 are formed in the cover frame 300, such that the venting part 500 inserted into the hollow portion 360 may be fixed between the first hole 342 and the second hole 344. Because the first hole 342 and the second hole 344 have different sizes, the venting part 500 cannot pass through the first hole 342 even though thermal runaway occurs in a particular battery module or battery cell, such that the venting part 500 may be prevented from being reversely introduced into the battery module.

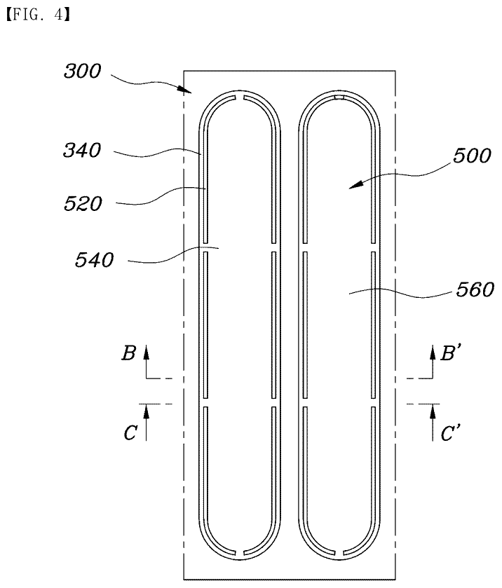

As illustrated in FIG. 4, the fractured portion 560 is formed on the venting part 500 and opened by gas or flame generated in the event of thermal runaway in the battery module. The fractured portion 560 is a portion configured to be opened along a temporarily cut line 520 formed on the venting part 500 and formed at a position corresponding to the venting hole 340 of the cover frame 300. Because the first hole 342 and the second hole 344 of the cover frame 300 are formed to face each other with the hollow portion 360 interposed therebetween, the fractured portion 560 is also disposed between the first hole 342 and the second hole 344.

As illustrated in FIG. 5, the fractured portion 560 needs to be larger in width or size than the first hole 342 and smaller in width or size than the second hole 344 because the fractured portion 560 needs to be fixed between the first hole 342 and the second hole 344 and a piece of the venting part 500, which has the fractured portion 560 opened in the event of thermal runaway in a particular battery module or battery cell, or gas or flame needs to be discharged to the outside without being reversely introduced into the battery module. In case that the fractured portion 560, the first hole 342, and the second hole 344 are different in widths or sizes as described above, pieces of the venting part 500 having the opened fractured portion 560 cannot pass through the first hole 342 smaller in size than the venting part 500 even in the event of thermal runaway in a particular battery module or battery cell, such that it is possible to prevent the pieces of the venting part 500 from being reversely introduced into the battery module or the battery cell and damaging internal devices.

Because the cover frame 300 is coupled to close one opened side of the battery module casing 100 as illustrated in FIG. 1, the cover frame 300 needs to be made of a metallic material identical or similar to a material of the battery module casing 100. In addition, the cover frame 300 constitutes a part of the battery module casing 100, and the battery module casing 100 constitutes a vehicle V. Therefore, the cover frame 300 and the battery module casing 100 may be made of aluminum, which is easy to process and has excellent durability among metallic materials, in order to prepare for various abnormal situations such as an external impact or the occurrence of a fire in the battery.

The cover frame 300 may be manufactured by an extrusion process method so that the plurality of hollow portions 360 is integrally formed in the cover frame 300. The hollow portion 360 needs to be disposed in the cover frame 300 and correspond to a position at which the battery cell is positioned in the battery module, and the plurality of hollow portions 360 needs to be formed to be spaced apart from one another in parallel. If the cover frame 300 is formed by extrusion first and then the hollow portion 360 is formed by post-processing, an error may occur between a position of the hollow portion 360 in the cover frame 300 and a position at which the battery cell is positioned in the battery module. For this reason, in the event of thermal runaway, gas or flame may not be smoothly vented, thermal propagation to the adjacent battery module or the adjacent battery cell cannot be prevented, and a disadvantage occurs in terms of costs.

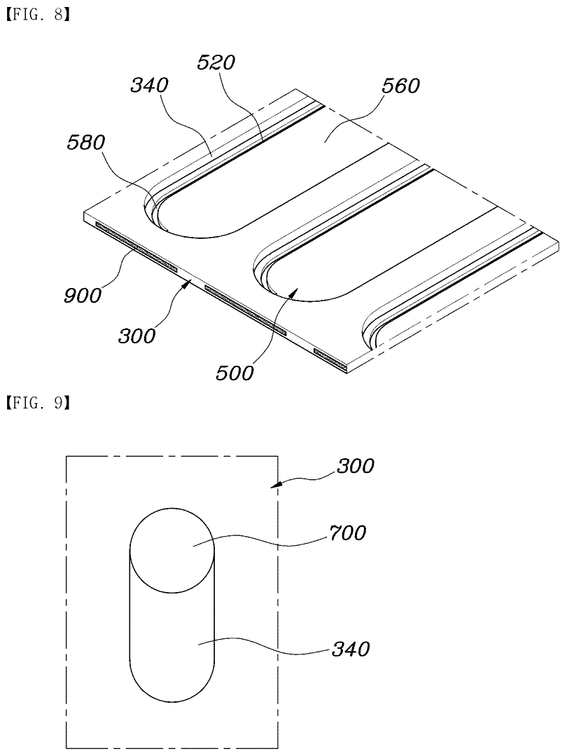

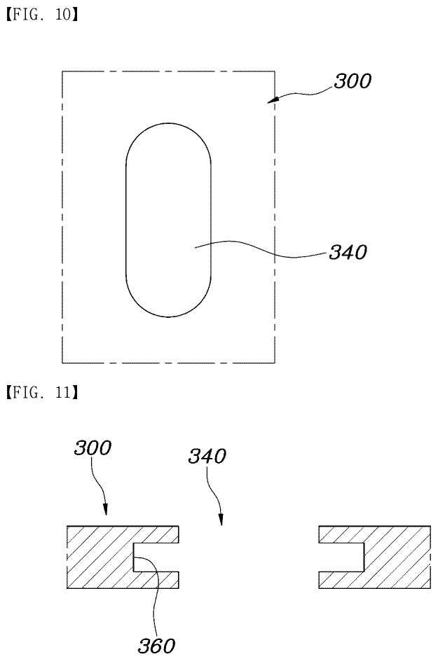

However, the venting hole 340 formed in the cover frame 300 may be formed by post-processing after the hollow portion 360 of the cover frame 300 is integrally formed by an extrusion process method. The venting hole 340 may be post-processed by a method of forming the venting hole 340 by processing a surface of the cover frame 300. As the post-processing method, the hole may be processed by a device 700 that forms the venting hole 340 by a method of polishing the inside of the cover frame 300, and there is a method of forming the venting hole 340 by punching the inside of the cover frame 300 by using a punching means or the like. FIG. 9 is a view illustrating that the venting hole 340 is formed by using the device 700 that forms the venting hole 340 by using a method of polishing or machining the inside of the cover frame 300. FIG. 10 is a view illustrating that the venting hole 340 is formed by using a punching means or a press device. Of course, the present disclosure is not limited to the illustrated embodiment as long as the venting hole 340, which allows the inside and the outside to communicate with each other, is formed in the surface of the cover frame 300 by the method of forming the venting hole 340.

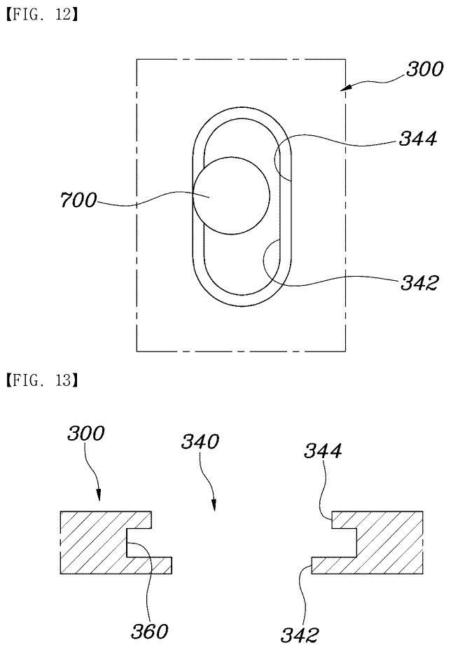

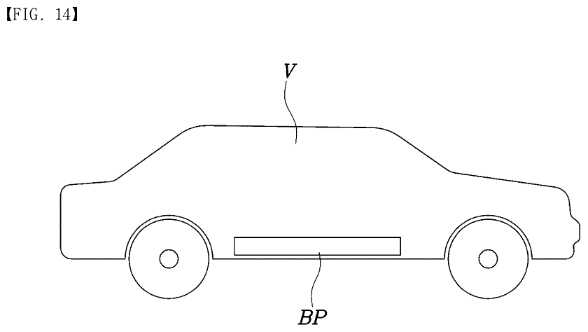

As described above, the venting hole 340 includes the first hole 342 formed in the inner surface of the cover frame 300, and the second hole 344 is formed in the outer surface of the cover frame 300. In case that the venting hole 340 is post-processed as illustrated in FIGS. 9 and 10, one venting hole 340, which has the same size and penetrates both the inside and the outside of the cover frame 300, is formed as illustrated in FIG. 11. Thereafter, the first hole 342 and the second hole 344 may be formed to have different widths or sizes. Therefore, as illustrated in FIG. 12, the second hole 344 may be formed to be larger in width or size than the first hole 342 by performing additional processing in the hole corresponding to the second hole 344 that is an outer portion of the cover frame 300. As a result, as illustrated in FIG. 13, the first hole 342 and the second hole 344 have different sizes, such that the venting part 500 may be fixed between the first hole 342 and the second hole 344, and a piece of the opened venting part 500 or gas or flame may be prevented from being reversely introduced into the first hole 342 even in the event of thermal runaway.

As illustrated in FIG. 1, the plurality of hollow portions 360 is formed in the cover frame 300 and the hollow portions 360 extend in the longitudinal direction of the cover frame 300. The end 320 of the hollow portion 360 has a hole shape into which the venting part 500 may be inserted at a point that meets the cover frame 300, as illustrated in FIG. 2. In order to coupling the cover frame 300 and the venting part 500, it is necessary to prevent the venting part 500 from being withdrawn to the end 320 of the hollow portion 360 after the venting part 500 is inserted into the end 320 of the hollow portion 360 having the hole shape.

Therefore, it is possible to suppress the withdrawal of the venting part 500 by pressing and deforming the end 320 of the hollow portion 360 in the state in which the end 320 of the hollow portion 360 is inserted into the venting part 500. The cover frame 300 is made of a metallic material and formed by the extrusion process method so that the hollow portion 360 is integrally formed therein. After the venting part 500 is inserted into the cover frame 300, an insertion point of the venting part 500, which is the end of the cover frame 300, i.e., the end 320 of the hollow portion 360, is pressed by a pressing means such as a press device and closes the end 320, thereby preventing the venting part 500 from being withdrawn from the cover frame 300.

As illustrated in FIG. 8, there is also a method of suppressing the withdrawal of the venting part 500 from the cover frame 300 by using a cross-sectional cover 900 (end cover) after the venting part 500 is coupled to the cover frame 300 by being inserted into the hollow portion 360 through the end 320 of the hollow portion 360. As illustrated in FIG. 2, the end 320 of the hollow portion 360 has a small hole shape formed in one surface or two opposite surfaces of the cover frame 300. After the venting part 500 is inserted into the hollow portion 360 through the end 320 of the hollow portion 360, the small hole shape is covered by the cross-sectional cover 900, and the end 320 of the hollow portion 360 is closed, such that the venting part 500 may be prevented from being withdrawn from the cover frame 300.

In this case, as illustrated in FIG. 8, a separate cap-shaped closure, which closes the end 320 of the hollow portion 360, may be used as the cross-sectional cover 900. There is a method that uses a closure in which a plurality of cap shapes is arranged in a band shape in accordance with an interval between the ends 320 of the hollow portions 360. The cross-sectional cover 900 may be considered as having various shapes other than the cap shape or the band shape as long as the cross-sectional cover 900 may block the end 320 of the hollow portion 360 and prevent the venting part 500 from being withdrawn from the cover frame 300.

Because the cover frame 300 is made of a metallic material, the end 320 of the hollow portion 360 may be closed by welding, a bonding agent, or the like after the venting part 500 is inserted through the end 320 of the hollow portion 360. In case that the bonding agent is melted under a high-temperature, high-pressure environment in the event of thermal runaway, the bonding agent cannot properly close the end 320 of the hollow portion 360. Therefore, a bonding agent made of a fire-resistance material may be used. The cover frame 300 is made of a metallic material, and the end 320 of the hollow portion 360 has a small hole shape, such that the end 320 of the hollow portion 360 may be closed by welding. As described above, the bonding agent, the welding, or the like is used to suppress the withdrawal of the venting part 500 from the cover frame 300 after the venting part 500 is inserted into the hollow portion 360, such that a coupling force between the cover frame 300 and the venting part 500 is further increased, which may prevent the battery module cover from separating even in the event of thermal runaway.

The venting part 500 is made of a fire-resistance material and coupled to the cover frame 300 by being inserted into the hollow portion 360 through the end 320 of the hollow portion 360. As illustrated in FIG. 4, the venting part 500 is inserted in a single line shape into the cover frame 300. As illustrated, because the venting part 500 is inserted in a single line shape, the venting part 500 is individually opened or closed even in the event of thermal runaway. Therefore, even when any one venting part 500 is opened by gas or flame, the propagation of gas or flame to the adjacent closed venting part 500 may be prevented. The venting part 500 is individually inserted, as a minimum unit with a single line shape, through the end 320 of the hollow portion 360. After the venting part 500 is inserted, the venting part 500 is coupled to the cover frame 300 while being prevented from being withdrawn from the cover frame 300 in various ways such as a pressing means, the cross-sectional cover 900, a bonding agent, welding, or the like.

The venting part 500 may be made of a material, such as mica (mica material), having heat resistance in order to prevent gas or flame, which is generated by thermal runaway in a particular battery module or battery cell, from propagating to the adjacent battery module or the adjacent battery cell. In case that the hollow portion 360 is formed in the longitudinal direction of the battery module as illustrated in FIG. 1, the venting part 500 is inserted into the cover frame 300 in the longitudinal direction. However, in some instances, the venting part 500 may be inserted in a width direction of the cover frame 300. As long as the venting part 500 may be individually controlled, the venting part 500 may be individually inserted into the cover frame 300 to constitute the cover assembly for a battery module by using new units in two or more lines instead of the unit in one line.

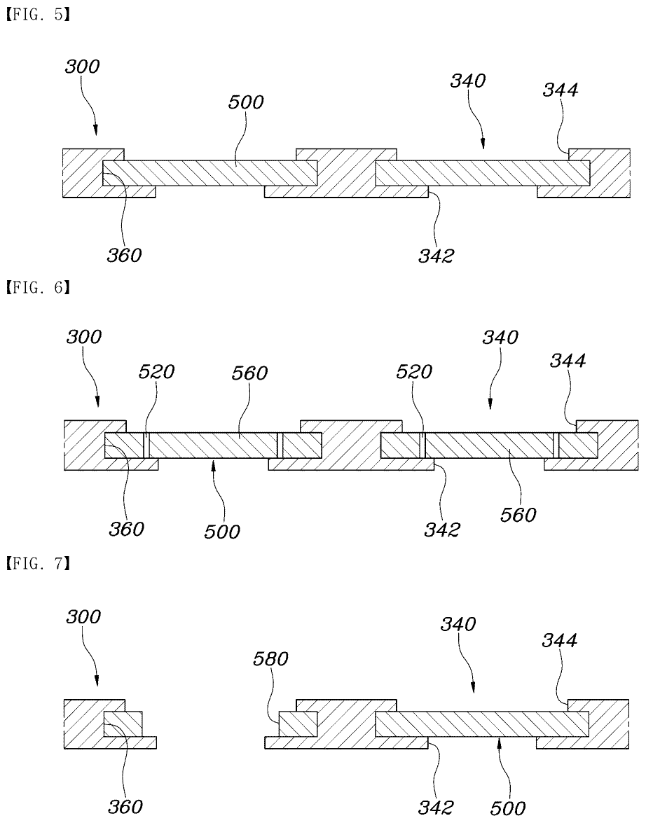

Meanwhile, as illustrated in FIG. 4, the temporarily cut line 520 is formed on the venting part 500. The temporarily cut line 520 is formed along a shape of the venting hole 340. The temporarily cut line 520 has a discontinuous shape having non-cut portions 540 in the middle of the temporarily cut line 520. As illustrated in FIGS. 6 to 7, the temporarily cut line 520 is a portion configured to be opened by being cut under a high-temperature or high-pressure environment in the event of thermal runaway in the battery module or the battery cell. The temporarily cut line 520 of the venting part 500 is cut when gas or flame is generated in the battery module or the battery cell, such that the fractured portion 560, which corresponds to the venting hole 340, is opened to form the through-hole 580. As illustrated in FIG. 7, the through-hole 580 of the venting part 500 is larger in width or size than the first hole 342, which is formed in the inner surface of the cover frame 300, and smaller in width or size than the second hole 344 formed in the outer surface of the cover frame 300, such that even in the event of thermal runaway, the venting part 500 is prevented from being reversely introduced into the battery module or the battery cell.

FIG. 7 is a view illustrating a state in which thermal runaway occurs at a side of a part of the venting part 500 because the venting part 500 is individually inserted. As illustrated, in case that thermal runaway occurs in the venting hole 340 in which the left venting part 500 is present, the venting part 500 is opened along the temporarily cut line 520 by gas or flame. In this case, the temporarily cut line 520 is cut along the fractured portion 560 corresponding to the venting hole 340. Therefore, the fractured portion 560 having a larger size than the first hole 342 prevents the pieces of the opened venting part 500 from being reversely introduced back into the first hole 342. In addition, the through-hole 580 is formed at a position at which the fractured portion 560 is opened, and the through-hole 580 is also opened along the temporarily cut line 520, such that the through-hole 580 is larger in size than the first hole 342 and smaller in size than the second hole 344. Even though thermal runaway occurs in the venting hole 340 illustrated on the left side in the drawings, the venting part 500 illustrated on the right side is inserted and controlled independently of the left venting part 500, such that the right venting part 500 is not opened together with the left venting part 500. In addition, the right venting part 500 is inserted into the cover frame 300 independently of the left venting part 500. Therefore, the right venting part 500 still closes the venting hole 340 even in the event of thermal runaway in the left venting part 500. As a result, gas or flame or the piece of the venting part 500, which is discharged from the left venting hole 340, is not introduced through the right venting hole 340, which may prevent or maximally delay thermal propagation.

Meanwhile, as illustrated in FIG. 14, the cover assembly for a battery module according to the present disclosure may be applied to the battery packs BP of various vehicles V such as internal combustion engine vehicles, electric vehicles, hybrid vehicles, and fuel cell electric vehicles. In addition to the vehicle V, the cover assembly for a battery module may be applied to the battery packs BP in various fields, such as industrial energy storage systems (ESSs) or household ESSs, and small-scale battery packs.

While the specific embodiments of the present disclosure have been illustrated and described, it will be obvious to those skilled in the art that the present disclosure may be variously modified and changed without departing from the technical spirit of the present disclosure defined in the appended claims.

1. A cover assembly for a battery module, the cover assembly comprising:
a cover frame configured to be coupled to one opened side of a battery module casing and to close the opened side of the battery module casing, the cover frame including:
a plurality of hollow portions extending in a longitudinal direction; and
a plurality of venting holes at locations that overlap the plurality of hollow portions, the plurality of venting holes being configured to penetrate the cover frame in a direction toward an inside of the battery module casing; and
at least one venting part inserted into a first hollow portion of the plurality of hollow portions and configured to close a respective venting hole of the plurality of venting holes, each at least one venting part having a portion that corresponds to the respective venting hole, each at least one venting part being configured to be opened when gas or flame is generated in the battery module.

2. The cover assembly of claim 1, wherein the first hollow portion extends to an end of the cover frame, and each at least one venting part is inserted into the first hollow portion through the end of the cover frame.

3. The cover assembly of claim 1, wherein the plurality of hollow portions are spaced apart from one another in parallel, the at least one venting part is provided as a plurality of venting parts, and each of the plurality of venting parts is individually inserted into corresponding hollow portions of the plurality of hollow portions and coupled to the cover frame.

4. The cover assembly of claim 1, wherein each of the plurality of venting holes comprises:
a first hole located in an inner surface of the cover frame; and
a second hole located in an outer surface of the cover frame, the first hole and the second hole being configured to communicate with each other through a corresponding hollow portion of the plurality of hollow portions, and the second hole being larger in width than the first hole.

5. The cover assembly of claim 4, wherein the at least one venting part further includes a fracturable portion configured to be opened when gas or flame is generated in the battery module,
wherein the first hole and the second hole are located to face each other with the first hollow portion interposed therebetween, such that the fracturable portion is located between the first hole and the second hole and
wherein the fracturable portion is larger in width than the first hole and smaller in width than the second hole.

6. The cover assembly of claim 1, wherein the cover frame is made of a metallic material, the cover frame is formed by an extrusion process method so that the plurality of hollow portions are integrally formed therein, and the plurality of venting holes are formed by forming a hole in the cover frame formed by extrusion.

7. The cover assembly of claim 6, wherein each of the plurality of venting holes comprises:
a first hole located in an inner surface of the cover frame; and
a second hole located in an outer surface of the cover frame, the second hole being larger in width than the first hole by additional processing.

8. The cover assembly of claim 1, wherein an end of the first hollow portion is pressed and deformed after the at least one venting part is inserted therein, such that the at least one venting part is prevented from being withdrawn.

9. The cover assembly of claim 1, wherein an end cover is located at an end of the first hollow portion, and the end cover prevents the at least one venting part, which is inserted into the first hollow portion from being withdrawn to an outside of the cover frame.

10. The cover assembly of claim 1, wherein an end of the first hollow portion is welded and closed in a state in which the at least one venting part is inserted, such that the at least one venting part is prevented from being withdrawn to an outside of the cover frame.

11. The cover assembly of claim 1, wherein the venting part is made of a fire-resistance material.

12. The cover assembly of claim 1, wherein the at least one venting part further includes a temporarily cut line located along a shape of the respective venting hole and
wherein the temporarily cut line is configured to be separated when gas or flame is generated in the battery module, and a portion of the at least one venting part is opened, such that a through-hole is formed.

13. The cover assembly of claim 12, wherein the respective venting hole comprises a first hole formed in an inner surface of the cover frame, and a second hole formed in an outer surface of the cover frame, and the through-hole of the venting part is larger in width than the first hole and smaller in width than the second hole.

14. A battery pack comprising the cover assembly for a battery module of claim 1.

15. A vehicle comprising the battery pack of claim 14.
